(19) United States
(12) Patent Application Publication
(10) Pub. No.: US 2022/0311244 A1
(43) Pub. Date: Sep. 29, 2022

(54) CONTROLLER SYSTEM FOR SOLAR TRACKING

(71) Applicant: SUN AND STEEL SOLAR LLC, Stateline, NV (US)

(72) Inventor: Robert B. Dally, Stateline, NV (US)

(21) Appl. No.: 17/702,639

(22) Filed: Mar. 23, 2022

Related U.S. Application Data
(60) Provisional application No. 63/165,556, filed on Mar. 24, 2021.

(51) Int. Cl. H02J 3/00

(52) U.S. Cl. CPC H02J 3/0073; H02J 3/004; H02J 2300/24

(57) ABSTRACT

A control system for a single-axis solar tracking system includes a controller that communicates control signals. An alternating current (AC) powerline is connected to the controller. The AC powerline supplies power control for one or more solar tracker drive motors and propagates the control signals to the one or more solar tracker drive motors.

### CROSS-REFERENCE TO RELATED APPLICATIONS

This application claims the priority benefit of U.S. Provisional Patent Application Ser. No. 63/165,556, filed Mar. 24, 2021, which is incorporated herein by reference in its entirety.

### TECHNICAL FIELD

One or more embodiments relate generally to the control for rotational panels, and in particular, by sending the control signal over the existing power line used to power the electric motors that power the drive of the rotating solar panels.

### BACKGROUND

Single axis trackers are mounting structures used for the controlled movement of photovoltaic solar panels and other solar collecting means from east to west to track the sun daily. A control system must be used to properly track the sun as well as perform back-tracking to prevent rows of solar panels from shading each other early in the morning after sunrise and late in the afternoon as the sun is setting.

### SUMMARY

One or more embodiments relate generally to the position control method for rotating solar panels on a motorized tracking system. One embodiment provides a control system for a single-axis solar tracking system that includes a controller that communicates control signals. An alternating current (AC) powerline is connected to the controller. The AC powerline supplies power control for one or more solar tracker drive motors and propagates the control signals to the one or more solar tracker drive motors.

Another embodiment provides a control system that includes a controller having at least one processor. The controller communicates control signals. A powerline is connected with the controller. Multiple single-axis tracker rows are connected to the powerline. Multiple drive motors are connected to the multiple single-axis tracker rows. The multiple single-axis tracker rows have position controlled by the controller via the control signals communicated to the multiple drive motors.

Yet another embodiment provides a control system that includes a controller having at least one processor. The controller communicates control signals. A powerline is connected with the controller. Multiple single-axis tracker rows are connected with photovoltaic solar panels and connected to the powerline. Multiple drive motors are connected to the multiple single-axis tracker rows. The multiple single-axis tracker rows have position controlled by the controller via the control signals communicated to the multiple drive motors. The multiple single-axis tracker rows have position controlled by the controller via the control signals communicated to the multiple drive motors. The control signals control the position of the multiple single-axis tracker rows by commands to periodically turn the multiple single-axis tracker rows in an east direction or a west direction for particular durations to provide solar track and back-track movements.

These and other features, aspects and advantages of the one or more embodiments will become understood with reference to the following description, appended claims, and accompanying figures.

### BRIEF DESCRIPTION OF THE DRAWINGS

FIG. 1 shows a block diagram of an electrical schematic by which one controller communicates to one or more motor controllers via at least one powerline signal communicated on a powerline, according to some embodiments.

FIG. 2 shows a block diagram of a conventional system by which a communication line runs parallel to, and in addition to the motor power lines.

FIG. 3 shows a more detailed view of the block diagram of FIG. 1 with a plurality of tracker rows, according to some embodiments.

FIG. 4 shows a more detailed view of the block diagrams of FIGS. 1 and 3, according to some embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to the position control method for rotating solar panels on a motorized tracking system. One embodiment provides a control system for a single-axis solar tracking system includes a controller that communicates control signals. An alternating current (AC) powerline is connected to the controller. The AC powerline supplies power control for one or more solar tracker drive motors and propagates the control signals to the one or more solar tracker drive motors.

Some embodiments provide a control system by which the communication line is in parallel to the power line for motor power, either by separate wiring or wirelessly. Some embodiments provide a control system at each and every tracker drive, which still requires a wireless communication system for emergency wind stow instructions. One embodiment uses the existing powerline as the carrier of signals instructing the tracker rows to move in an eastern or western direction. Only one controller is required for an entire field of solar trackers, which transmits (through the powerline) go-east or go-west instruction signals that reach all receivers on the powerline. One embodiment uses east and west tilt limit switches, typically set at ±45°, to stop each and every row for limiting them from further movement, even if they received one or more signals to move beyond the limit. Twice a day in the daily routine of starting at sunrise with the tracker of solar panels horizontal (“flat”), the movements include: back-tracking to the east limit, tracking the sun to the west limit established by the limit switch, and then back-tracking to end up horizontal at sunset.

Twice a day the controller blindly knows that the tracker rows are all located at their east and west limits, by over-driving all of them until each row hits its east and/or west limit switches. One or more embodiments includes transmitters and receivers disposed at both the control room (or control panel) and at all, or a subset of, the tracker rows in order to send tracker status information (e.g., a tracker row tilt sensor information, motor current sensor information, and other telemetry information) back to the control room for two-way communication. Some embodiments provide one-way communication with limit switches acting as the tilt stops and indicator information.

One or more embodiments are directed to a communication method by which the signal(s) to move tracker rows (e.g., to track or to back-track) is sent on an existing powerline that feeds electrical alternating current (AC) power to the drive motors.

It should be noted that most conventional single-axis trackers utilize a large number of controllers via placement of one controller on each tracker row. Each tracker controller requires a battery, or other energy storage device in order to turn the motor when the local controller instructs it to move. The battery must withstand harsh outdoor conditions, and must be replaced per a routine maintenance schedule. Other conventional single-axis trackers use wireless communication to constantly keep track of all tracker rows via complicated software.

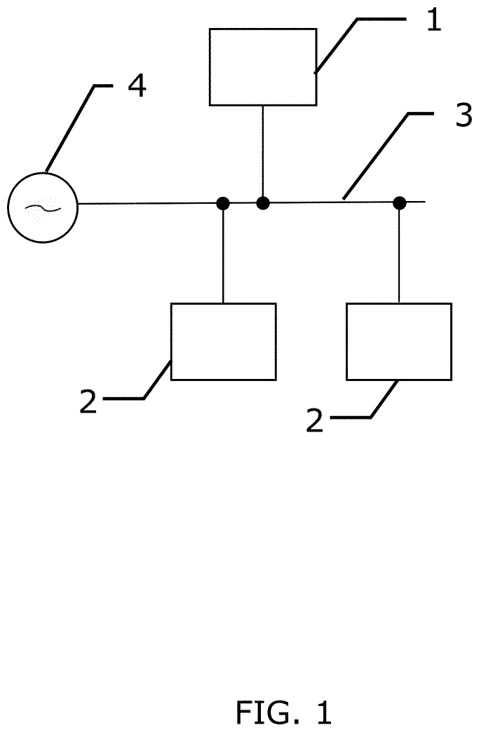

FIG. 1 shows a block diagram of an electrical schematic by which one controller 1 communicates to one or more motor controllers 2 (or drive box(es)) via at least one powerline signal communicated on a powerline (or power distribution system) 3, according to some embodiments. The at least one powerline signal communicated on the powerline 3 emanates from the grid (or service panel) 4 and has a destination to the one or more motor controllers 2 to power electrical drive motors of solar tracking rows. The signal communication from the grid 4 includes instructions or commands (e.g., move east, move west), and may be a one-way or two-way communication with the one or more motor controllers 2.

In some embodiments, a simple one-way signal from the controller 1 via the grid 4 to all receiver boxes of the one or more controllers 2 of the trackers rows works reliably when based simply on timing and on east and west limit switches. The controller 1 receives its power from the powerline 3 fed by the grid 4 (or a backup power supply), and sends the move-east and move-west signals on the very same power distribution system 3. In one or more embodiments, a more complicated system may have transmitters and receivers at both ends, meaning both at the control room or wherever the controller 1 is placed, and at one or more of the motor controllers 2, to send tracker telemetry from a number of addressed trackers to the controller (e.g., in a control room). In some embodiments, both one-way and two-way communication signals propagate on the power distribution system powerline 3 (wires) that feeds power to each and every one of the one or more motor controllers 2.

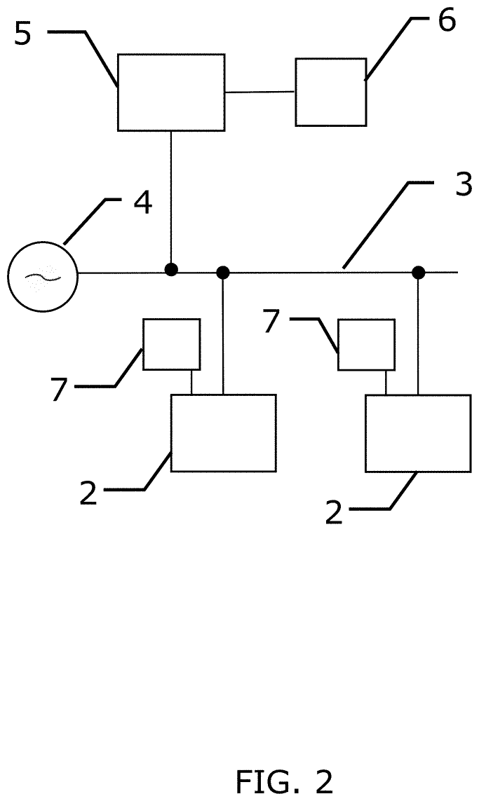

FIG. 2 shows a block diagram of a conventional system by which a communication line runs parallel to, and in addition to the motor power lines. Unlike the embodiments described herein, this type of conventional system requires additional equipment including transmitters 6 and receivers 7 that are placed in underground trenching or are otherwise wireless receivers 7 and repeaters. Wireless transmitters 6, repeaters, and receivers 7 require power (from drive box 5 including a power source) to operate and can fail in poor weather. Communication wires, cables, or fiber require additional trenching and materials including transmitters 6 and receivers 7. Both wire and wireless forms of this conventional type of system increase costs, maintenance and reduces reliability.

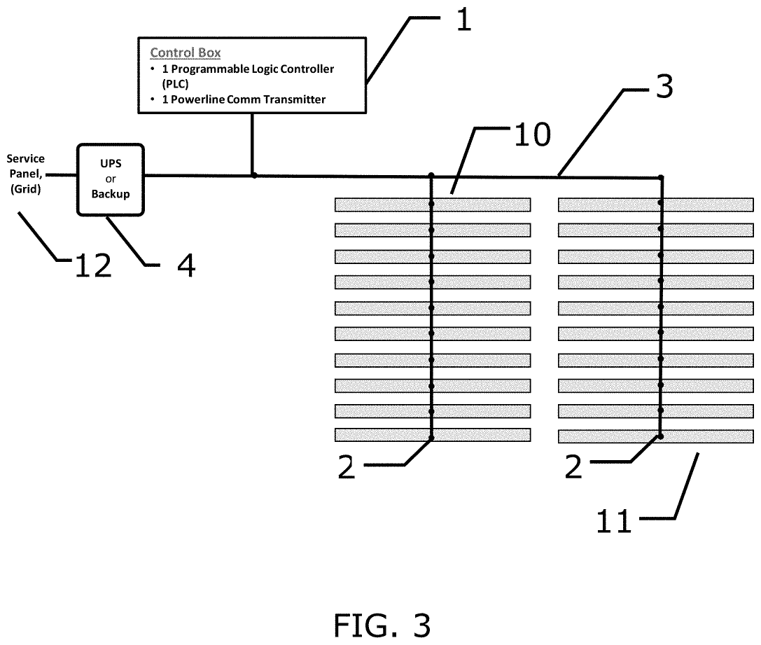

FIG. 3 shows a more detailed view of the block diagram of FIG. 1 with a plurality of tracker rows (e.g., 20 tracker rows (in columns 10, 11), according to some embodiments. Each tracker row has a motor controller 2 to deliver power to the motor and uses limit switches to interrupt that power to the motor when the tracker row reaches its east and west tilt limits. In one example embodiment, each of the motor controllers 2 (e.g., 20 motor controller electrical boxes) receives their power and their move instruction signal from the power distribution system powerline 3 (wires). The controller 1 sends the move instruction signals (go east or go west) to all of the motor controllers 2 on the power distribution system powerline 3 (wires). In some embodiments, the service panel (grid) 12 may include an uninterruptable power source (UPS) or backup power source 4 connected to the service panel (grid) 12. In one or more embodiments, the controller 1 may include a programmable logic controller (PLC) and a powerline communication transmitter. In one example embodiment, the tracker rows 10, 11 with the motor controllers 2 (e.g., drive boxes) may be included in a 1 megawatt (MW) photovoltaic (PV) system.

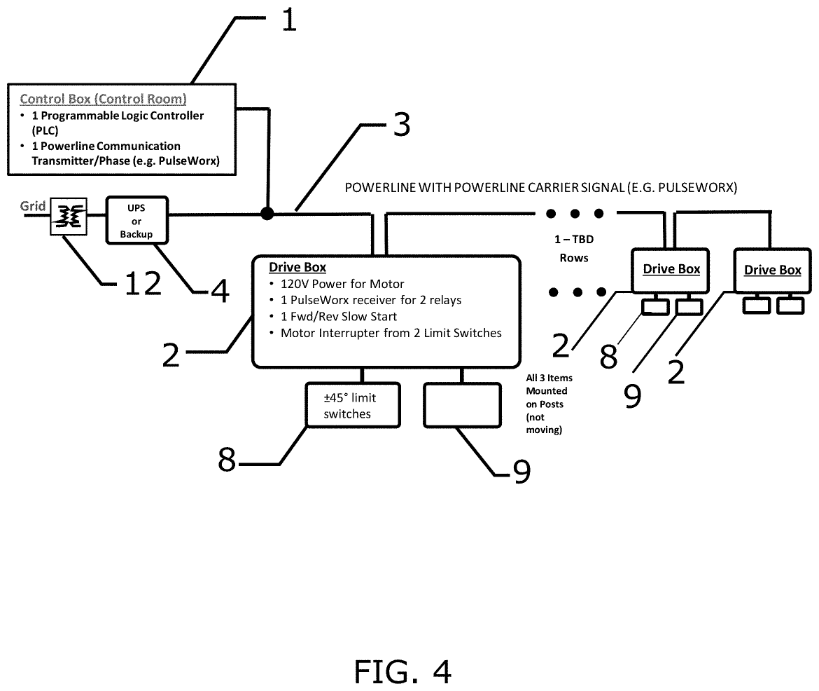

FIG. 4 shows a more detailed view of the block diagrams of FIGS. 1 and 3, according to some embodiments. The one or more motor controllers 2 (or drive box) feed power to an external drive motor 9 (e.g., a ⅓ Horsepower (HP) motor, etc.) and may be controlled by motor interruption circuitry from two (simple) limit switches 8 (e.g., ±45° limit). In one example embodiment, the one or more motor controllers 2 (or drive box) may include a 120V power source for the external drive motor 9, one PulseWorx receiver for two relays, a forward/reverse slow start circuit, and a motor interrupter controlled from the two limit switches 8. The controller 1 (or control box, control room, etc.) may include a PLC, and a powerline communication transmitter/phase (e.g., PulseWorx). One or more additional drive boxes 2 connected to limit switches 8 and external drive motors 9 are connected to the powerline 3. All of the field components (one or more motor controllers 2, powerline 3, grid 4 may be disposed on stationary mounts, for example on existing tracker posts; they are not mounted on the moving portion of the single-axis tracker.

Some embodiments provide a single-axis tracker control system that uses one controller 1 (e.g., PLC, etc.) to send go-east and go-west command or instruction signals to a multitude of tracker motors (motor controllers 2) via a communication signal propagating on the powerline 3. The signal is transmitted across the entire power line 3, which enables each motorized tracker row to move east, move west, or to sit and wait (no signal). Daily, the one-way signal causes movement of the trackers a bit at a time, no faster than the moving sun, all the way to their east limit switches 8 (shortly after sunrise), and then all the way to their west limit switches 8 (mid-afternoon). This establishes tracker row position (tilt angle) twice a day. Two-way telemetry may also be used, for example to send to the controller 1, from a tracker's tilt sensor, the angular position of that single-axis tracker. The solar output from the attached photovoltaic solar panels, which is monitored already, indicates if and when a single-axis tracker row is not moving.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A control system for a single-axis solar tracking system, comprising:
a controller that communicates control signals; and
an alternating current (AC) powerline coupled to the controller, the AC powerline supplying power control for one or more solar tracker drive motors and propagating the control signals to the one or more solar tracker drive motors.

2. The system of claim 1, wherein communication for the controller is one-way or two-way on the AC powerline.

3. The system of claim 2, wherein the controller controls position for a plurality of single-axis solar tracker rows.

4. The system of claim 3, wherein each of the plurality of single-axis tracker rows are controlled by the control signals to move in an east or west direction.

5. The system of claim 4, wherein the controller is the only controller that controls movement of the plurality of single-axis tracker rows via the communication signals.

6. The system of claim 4, wherein the one or more solar tracker drive motors are coupled to one or more tilt limit switches that limit movement of each of the plurality of single-axis tracker rows.

7. The system of claim 6, wherein the one or more tilt limit switches limit movement of each of the plurality of single-axis tracker rows to a particular set tilt limit threshold.

8. The system of claim 3, wherein the controller and each of the plurality of single-axis solar tracker rows comprise at least one transmitter and at least one receiver, and the at least one receiver of the controller receives status information from the at least one transmitter of the plurality of tracker rows.

9. The system of claim 8, wherein the status information comprises one or more of tracker row tilt sensor information, motor current sensor information or telemetry information.

10. A control system, comprising:
a controller comprising at least one processor, wherein the controller communicates control signals;
a powerline coupled with the controller;
a plurality of single-axis tracker rows coupled to the powerline; and
a plurality of drive motors coupled to the plurality of single-axis tracker rows, wherein the plurality of single-axis tracker rows has position controlled by the controller via the control signals communicated to the plurality of drive motors.

11. The system of claim 10, wherein the control signals control the position of the plurality of single-axis tracker rows by commands to periodically turn the plurality of single-axis tracker rows in an east direction or a west direction for particular durations to provide solar track and back-track movements.

12. The system of claim 11, wherein the solar track and back-track movements continue until the plurality of single-axis tracker rows meet an east limit and west limit via limit switches.

13. The system of claim 12, wherein communication for the controller is one-way or two-way on the powerline.

14. The system of claim 13, wherein the controller and each of the plurality of single-axis solar tracker rows comprise at least one transmitter and at least one receiver, and the at least one receiver of the controller receives status information from the at least one transmitter of the plurality of tracker rows.

15. The system of claim 14, wherein the status information comprises one or more of tracker row tilt sensor information, motor current sensor information or telemetry information.

16. A control system, comprising:
a controller comprising at least one processor, wherein the controller communicates control signals;
a powerline coupled with the controller;
a plurality of single-axis tracker rows coupled with photovoltaic solar panels and coupled to the powerline; and
a plurality of drive motors coupled to the plurality of single-axis tracker rows; wherein:
the plurality of single-axis tracker rows has position controlled by the controller via the control signals communicated to the plurality of drive motors; and
the control signals control the position of the plurality of single-axis tracker rows by commands to periodically turn the plurality of single-axis tracker rows in an east direction or a west direction for particular durations to provide solar track and back-track movements.

17. The system of claim 16, wherein the solar track and back-track movements continue until the plurality of single-axis tracker rows meet an east limit and west limit via limit switches.

18. The system of claim 16, wherein communication for the controller is one-way or two-way on the powerline.

19. The system of claim 18, wherein the controller and each of the plurality of single-axis solar tracker rows comprise at least one transmitter and at least one receiver, and the at least one receiver of the controller receives status information from the at least one transmitter of the plurality of tracker rows.

20. The system of claim 19, wherein the status information comprises one or more of tracker row tilt sensor information, motor current sensor information or telemetry information.
